(19) United States
(12) Patent Application Publication
(10) Pub. No.: US 2005/0165745 A1
(43) Pub. Date: Jul. 28, 2005

(54) Method and apparatus for collecting user feedback based on search queries

(75) Inventors: Anthony R. Hagale, Austin, TX (US); Anthony N. Liguori, Austin, TX (US); Jerone B. Young, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/756,127

(22) Filed: Jan. 13, 2004

(51) Int. Cl. G06F 17/30

(52) U.S. Cl. 707/3

(57) ABSTRACT

The present invention provides a method and apparatus for collecting user feedback based on search queries. The method comprises receiving a search term from a user, providing a search result to the user based on comparing at least a portion of the received search term with at least a portion of one or more entries stored in a database and providing a feedback module to the user to monitor at least one online action of the user in response to providing the search result. The method further provides for receiving, from the feedback module, information associated with the at least one monitored user action to adjust at least one entry stored in the database.

### BACKGROUND OF THE INVENTION

1. Field of the Invention

The invention generally relates to word searches, and, in particular, to a method and apparatus for collecting user feedback from search queries.

2. Description of the Related Art

Search engines are useful in finding specific information on the vast expanse of the Internet, such as the World Wide Web (“Web”). Without the use of search engines, it may be difficult to locate desired keywords on the Web without knowing a specific Universal Resource Locator (URL), especially with exponential growth of the Internet.

Various types of search engines exist today, including, but not limited to, those that are powered by crawlers (or spiders), those that are powered by human submissions, and those that are a combination of the two. Crawler-based engines, for example, send crawlers into cyberspace, where they search webpages for words, and then follow various hyperlinks found on these webpages to access other websites. In this way, the crawler quickly begins to travel, spreading out across the more widely used portions of the web to build and/or update the database of words. The crawler may periodically return to the sites to check for any information that has changed, and the frequency with which this happens is determined by the administrators of the search engine. In contrast to crawler-based engines, human-powered search engines rely on humans to submit information that is subsequently indexed and catalogued. Typically, only information that is submitted is included in the index.

When a search engine receives a query from a user, the search engine searches the created database to respond to the search query. These databases tend to be large because of the enormous amount of information that has been compiled over time. Because queries from users are searched against the compiled database of information, the ability of a search engine to effectively provide pertinent search results to the user is based in part on the relevancy of information stored in the database. Thus, it is not surprising that the utility of a search engine is oftentimes measured against the ratio of relevant-to-irrelevant links it provides based on a search query.

Conventional methods of swinging this ratio towards the better end of the equation include the use of complex, static, or passive algorithms, some of which may entail measuring the number of other pages that provide a link to the page in question, or by dynamically altering the weight of the ranking based upon the number of other users of the search engine that also selected the same hyperlink that was provided. These conventional methods, however, are generally inadequate for providing relevant information quickly and efficiently, in part because of the limited range of information that is available to improve, or even optimize, the data that is stored in the databases associated with the search engines.

The present invention is directed to addressing, or at least reducing, the effects of, one or more of the problems set forth above.

### SUMMARY OF THE INVENTION

In one aspect of the instant invention, a method is provided for collecting user feedback based on search queries. The method comprises receiving a search term from a user and providing a search result to the user based on comparing at least a portion of the received search term with at least a portion of one or more entries stored in a database. The method further comprises providing a feedback module to the user to monitor at least one online action of the user in response to providing the search result. The method further calls for receiving, from the feedback module, information associated with the at least one monitored user action to adjust at least one entry stored in the database.

In another aspect of the instant invention, an apparatus is provided for collecting user feedback based on search queries. The apparatus comprises a storage unit that has a database stored therein, which is communicatively coupled to a control unit. The control unit is adapted to receive a search term from a user, provide a search result to the user based on comparing at least a portion of the received search term with at least a portion of one or more entries stored in the database, and provide a feedback module to the user to monitor at least one online action of the user in response to providing the search result. The control unit is further adapted to receive, from the feedback module, information associated with the at least one monitored user action to adjust at least one entry stored in the database.

In yet another aspect of the instant invention, an article comprising one or more machine-readable storage media containing instructions is provided for collecting user feedback based on search queries. The instructions, when executed, enable a processor to receive a search term from a user, provide a search result to the user based on comparing at least a portion of the received search term with at least a portion of one or more entries stored in a database, and provide a feedback module to the user to monitor at least one online action of the user in response to providing the search result. The instructions further enable a processor to receive, from the feedback module, information associated with the at least one monitored user action to adjust at least one entry stored in the database.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system including a search engine module that is capable of improving the relevancy of the results it provides based on user feedback.

FIG. 2 illustrates one way the search engine module of FIG. 1 may search for terms on the network, in accordance with one embodiment of the present invention.

FIG. 3 depicts a flow diagram of one aspect of the search engine module of FIG. 1, in accordance with one embodiment of the present invention.

FIG. 4 depicts a block diagram of a processor-based system that may be implemented in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

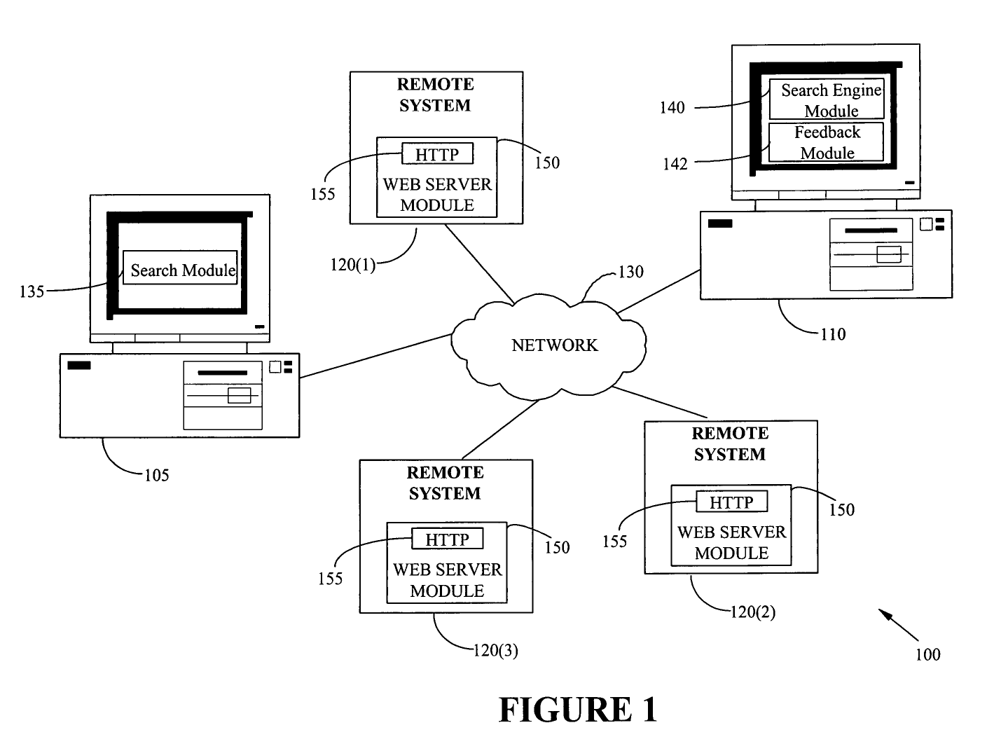

Referring to FIG. 1, a communications system 100 is illustrated in accordance with one embodiment of the present invention. The communications system 100 includes a plurality of processor-based devices 105, 110, 120(1-3) that may be communicatively coupled by a network 130, such as by a private network or a public network (e.g., the Internet). The devices 105, 110, and 120(1-3) may be any variety of processor-based devices that are capable of communicating with each other, and may include, but are not limited to, computers, portable electronic devices, Internet appliances, and the like. Although not shown, the various devices 105, 110, and 120(1-3) may be coupled to the network 130 through a router (not shown), gateway (not shown), or by other intervening, suitable devices.

The device 105 includes a search module 135 that allows a user to input one or more search terms that can be provided to a search engine module 140 of the device 110. Although not so limited, an example of a search module may be a web browser application that allows a user to access a desired website, such as a search engine website, to search for the desired terms or words.

In FIG. 1, the processor-based device 110 includes a search engine module 140 that provides a variety of features (discussed below), in accordance with one or more embodiments of the present invention. It should be appreciated that while a single module 140 is depicted in FIG. 1, that in alternative embodiments, the search engine module 140 may comprise a plurality of modules, with each module capable of providing one or more of the desired features. For example, the search engine module 140 may include a module for creating and maintaining an index of searchable terms, a module for providing results to a user in response to a search query, and a module for revising the index so that relevant, meaningful results are provided in response to a query based on user feedback.

In one embodiment, the search engine module 140 maintains a database of select words that may be found on the network 130. For example, the search engine module 140 may search and maintain a database of words that are found at various websites or in files associated with the various devices 120(1-3) that are coupled to the network 130. In one embodiment, each device 120(1-3) may be considered a node on the network 130 that may have an associated website that can be searched for contents.

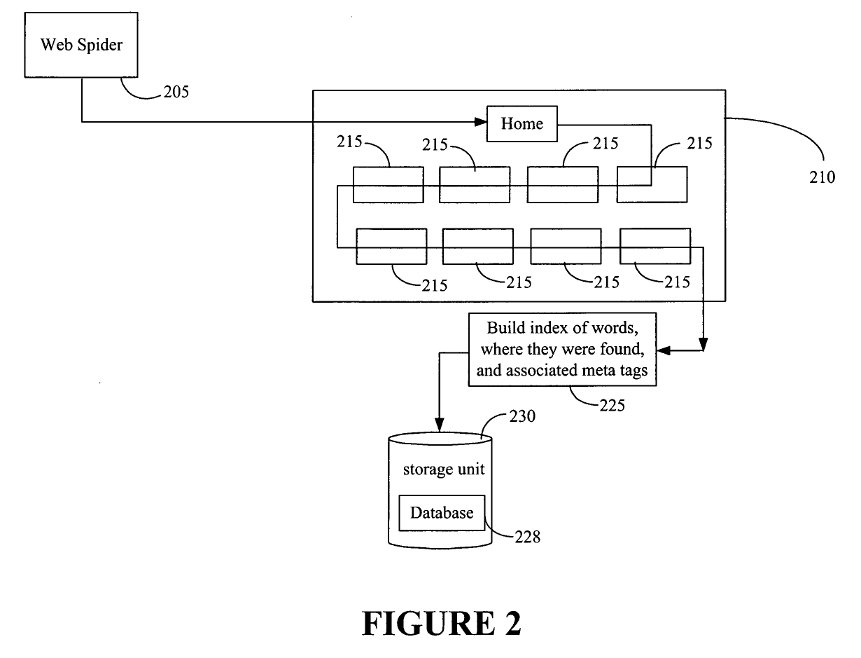

The words found during a search and stored in the database may also contain an associated location identifying where those words can be found on the network 130. Furthermore, the database may also include meta tags, which generally provide information about a stored webpage, information such as who created the webpage, how often it was updated, what the webpage was about, and which keywords represented the webpage's content, page rank of the associated webpage, and so forth. A flow diagram of how the search engine module 140 may generate a database of words is described later with reference to FIG. 2. Once created, the database may be searched by the users on the network 130. The search engine module 140 may, from time to time, update the database as the contents of the various websites on the network 130 change.

In accordance with one embodiment of the present invention, the search engine module 140 maintains its database such that the more meaningful (or relevant) results are returned for each query. Specifically, and as is described in greater detail below, the search engine module 140 updates its database based on feedback provided by users who use the services of the search engine module 140. In one embodiment, the search engine module 140 uses a feedback module 142 to transparently receive feedback from the user. The feedback module 142 may be any one of a variety of types of software applications, including a Java applet or a browser plug-in, for example.

In one embodiment, the search engine module 140 provides the feedback module 142 to the user's device (e.g., processor-based device 105), and the feedback module 142 thereafter monitors the user's activities during the search and/or after the search is complete, and then provides the gathered information (i.e., feedback) to the search engine module 140. Based on the user feedback, the search engine module 140 may employ robust algorithms to enable the search engine module 140 to provide more meaningful or relevant results to users during subsequent search queries. The above cycle may be repeated as many times as desired for any desired number of users to improve the relevancy of the stored data.

In an alternative embodiment, the search engine module 140 may employ proxies (not shown) to collect feedback from the users. For example, the exchange of information between the search engine module 140 and the user's device may occur through a proxy (or, specifically, a reverse proxy). In such an embodiment, the search engine module 140 may or may not employ the feedback module 142, depending on the implementation design. Thus, depending on the particular implementation, the search engine module 140 may employ the feedback module 142, a proxy, or a combination thereof to collect user feedback data.

In the illustrated embodiment, the devices 120(1-3) include a web server module 150, which may be capable of receiving requests over the network 130 and responding to such requests. For example, the web server module 150 may include an HTTP (Hypertext Transfer Protocol) service routine 155 that is capable of receiving HTTP requests over the network 130, as well as sending HTTP responses over the network 130. HTTP specifies how a client and server may establish a connection, how the client may request data from the server, how the server may respond to the request, and how the connection may be closed. One version of HTTP is described in RFC 2068, entitled “Hypertext Transfer Protocol—HTTP/1.1,” dated January 1997. In an alternative embodiment, the HTTPS protocol may also be employed. The devices 120(1-3) may host one or more websites that can be accessible by the search engine module 140 of the device 110. As noted, the search engine module 140 may search the websites for various words and generate a searchable database.

The network 130 of FIG. 1 may be a packet-switched data network, such as a data network according to the Internet Protocol (IP). Examples of the network 130 may include local area networks (LANs), wide area networks (WANs), intranets, and the Internet. One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 130 may also include other types of packet-based data networks in further embodiments. Examples of such other packet-based data networks include Asynchronous Transfer Mode (ATM), Frame Relay networks and the like.

As utilized herein, a “network” may refer to one or more communications networks, channels, links, or paths, and systems or devices (such as routers) used to route data over such networks, channels, links, or paths.

The various modules 135, 140, 142, 150 illustrated in FIG. 1 are implemented in software, although in other implementations these modules may also be implemented in hardware or a combination of hardware and software. Additionally, although the modules 135, 140, 142, 150 are shown in FIG. 1 as being associated with individual processor-based devices, it should be appreciated that in alternative embodiments, one or more portions of any of these modules may be distributed across a plurality of processor-based devices. For example, one or more portions of the search engine module 140 may be distributed in a clustered environment, across a plurality of processor-based devices. In such an embodiment, even though the search engine module 140 may be resident across various devices, it may appear as a single, logical application or interface to the end user.

It should be understood that the configuration of the communications system 100 of FIG. 1 is exemplary in nature, and that fewer, additional, or different components may be employed in other embodiments of the communications system 100. For example, in one embodiment, although not shown in FIG. 1, the devices 105 and 110 may include the web server module 150 and HTTP service routine 155. While the communications system 100 in the illustrated example includes five processor-based devices 105, 110, 120(1-3), in other embodiments, the number of systems employed may be more or fewer. In one embodiment, the search module 135 and the search engine module 140 may reside in the same system. Similarly, other configurations may be made to the communications system 100 without deviating from the spirit and scope of the invention.

FIG. 2 illustrates a flow diagram illustrating at least one operation performed by the search engine module 140 of FIG. 1 to generate a database of words found on the network 130, in accordance with one embodiment of the present invention. Although not so limited, for ease of illustration, it is herein assumed that the network 130 is the Internet, and the search engine module 140 is a World Wide Web search engine. Generally, the search engine module 140 may employ software tools, sometimes referred to as “spiders” or “crawlers,” to build and maintain a database of words found on the websites. The spider, shown as block 205 in FIG. 2, accesses one or more webpages 210 on the network 130 and builds a list of words based on the contents of the webpages 210.

Those skilled in the art should appreciate that the path that the spider 205 takes in searching the Internet for words may vary from one implementation to another. In FIG. 2, for example, the spider 205 uses the webpage 210 as its starting point to search for words, and then follows various hyperlinks 215 found on the webpage 210 to access other websites. In this way, the spider 205 quickly begins to travel, spreading out across the more widely used portions of the web to build and/or update the database of words. Of course, in other embodiments, other database building and updating techniques may be employed without deviating from the spirit and scope of the present invention.

In FIG. 2, when the spider 205 searches the webpage 210, it takes notes of at least two things—the words within the page, and the location where the words were found. The search engine module 140 builds (at block 225) an index of the words and their respective location. In one embodiment, the search engine module 140 may also store meta tags (mentioned above) for each entry. The index of words may be stored in a database 228 on a storage unit 230, which may be located within in the processor-based device 110 (see FIG. 1), or, alternatively, may be located at a remote location that is accessible by the processor-based device 110.

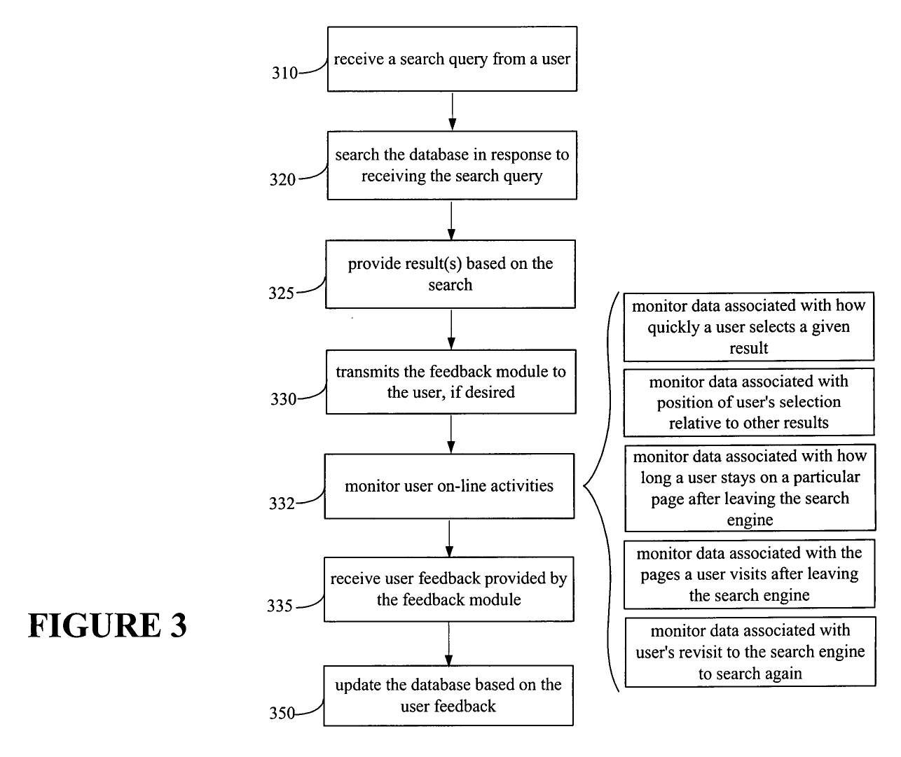

Once the searchable database 228 is created, the search engine module 140 may employ the feedback module 142 to gather information from the users to improve the database 228 so that the relevance of the contents of the database, such as hyperlinks, can be improved, thereby increasing the usefulness and effectiveness of the search engine. In an alternative embodiment, one or more embodiments of the present invention may be employed to improve the relevancy of the contents of the database 228 as the contents are being compiled to create an initial database 228. One way of updating the contents of the database 228 for improved relevancy is illustrated next in FIG. 3.

Referring now to FIG. 3, a flow diagram of at least one aspect of the search engine module 140 of FIG. 1 is illustrated, in accordance with one embodiment of the present invention. The search engine module 140 receives (at 310) a search query from a user, who, in the illustrated example, is assumed to be situated at the processor-based device 105 (see FIG. 1). The search query may include a word or a combination of words that the user desires to search on the network 130. The search engine module 140 searches (at 320) for word(s) provided by the user in its database 228 (see FIG. 2), and provides the results (at 325) to the user. For example, if no matches are found, the search engine module 140 may indicate as such. On the other hand, if the search term matches one or more of the entries stored in the database 228, the search engine module 140 displays to the user any results that matched the search criteria. In one embodiment, the results may be displayed in the order of their relevancy.

In accordance with one embodiment with the present invention, in association with providing the results (at 325) to the user, the search engine module 140 transmits (at 330), if desired, a copy of the feedback module 142 to the processor-based device 105. In one embodiment, the search engine module 140 may query the processor-based device 105 to determine if it already has a copy of the feedback module 142. The processor-based device 105 may already have a copy of the feedback module 142, for example, from a previous Web access (i.e., a cached copy), or the user may have manually installed a local copy at an earlier time. If it is determined that the processor-based device 105 already has a copy of the feedback module 142, the search engine module 140, in one embodiment, may not transmit (at 330) another copy to the user.

As the user peruses the results provided by the search engine module 140, and eventually selects one or more of the provided results (e.g., hyperlinks), the feedback module 142 may monitor (at 332) the user's activities. After a selected (or programmable) amount of time or, alternatively, after some selected (or programmable) amount of data has been collected, the feedback module 142 may provide the data to the search engine module 140. In one embodiment, the feedback collected may be based on the user's online actions or activities while the user continues to use the search engine or continues with the search. In an alternative embodiment, the feedback may be based on the user's online actions or activities after the search has been completed or the user has left the search engine. In yet another embodiment, the feedback collected may be based in part on the user's activities during the search, as well as the user's activities after the search.

The types of activities monitored may vary from one implementation to another. As an example, the feedback module 142 may monitor how quickly a user selects a given result provided by the search engine. This action by the user may occur, for example, while the user is still using the search engine. A relative quick selection from the provided results may be indicative of a highly relevant result. As another example, the feedback module 142 may monitor the position of a search result (e.g., hyperlink) selected by the user relative to the other provided results. Thus, in this example, the relative position of the user's selection may be indicative of the relevancy of that result. In this example, a more “static” indicator (e.g., relative position of the selected hyperlink) is monitored, as opposed to the first example in which a variable indicator (e.g., selection time) is monitored. As yet another example, the feedback module 142 may monitor how long a user stays on a particular page after leaving the search engine or may determine which pages a user visits after leaving the search engine. In another example, the feedback module 142 may monitor if the user comes back to the search engine to search again, which may indicate that a less relevant (or even an irrelevant) result may have been provided the first time. As can be seen based on the above-noted examples, the feedback module 142 may monitor the user's activities that occur during a search, after a search, or anytime therebetween. In one embodiment, the feedback module 142 may monitor any combination of the above-described activities and provide the monitored results to the search engine module 140. Of course, in addition to the above-noted examples, other desirable actions that are indicative of a relevance of a result may also be monitored and provided to the search engine module 140.

The data provided by the feedback module 142 is received (at 335) by the search engine module 140. Based on the received feedback, the search engine module 140 updates (at 350) the contents of its database 228 in an effort to improve the relevancy of its database 228 contents. Depending on the particular implementation and the particular context, the search engine module 140 may update (at 350) the database by revising entries stored therein, deleting stored entries, or adding new entries. For example, if the user's actions reveal that, based upon the submitted search criteria, the user visited webpages that were not previously known to the search engine module 140, the search engine module 140 may add a new entry to its database 228 to reflect the newly discovered webpage. As another example, if the user's actions indicate that the provided result was not very useful to the user, the search engine module 140 may lower the relevance associated with the provided result, or, if appropriate, may even remove the entry from the database 228. An entry may be removed, for example, if it is determined to be an invalid hyperlink. In one embodiment, in addition to the stored words and their associated locations, the search module 132 may also modify the meta tags associated with one or more entries of the database 228, as discussed below.

In one embodiment, an entry in the database 228 may be designated as more relevant compared to other stored entries based on an associated weighted value assigned to that entry. This weighted value, which can be a scaled value, may be part of a meta tag, for example. In one embodiment, the weighted value may represent the ranking of a particular entry in the database 228 relative to other entries in a manner analogous to the way “page ranking” is employed by some search engines, such as Google®, for example. Of course, in alternative embodiments, other techniques may be employed to designate the relevancy of the stored entries. This designation can be stored in the meta tags, which can then be updated based on the received user feedback.

In accordance with one or more embodiments of the present invention, and for reasons discussed above, it is possible to improve the relevancy of the contents of the database 228 to improve the ratio of relevant to irrelevant results. As explained, this may be accomplished, in one embodiment, by taking advantage of the conventional spidering and indexing techniques and combining them with the data collected based on users' activities. In one embodiment, the relevance of the results can be ascertained by the actual, on-line actions of the users, thus allowing the search engine module 140 to effectively and efficiently determine the usefulness of the results that were provided to the user. In this manner, a finer granularity in relevance can be achieved. Moreover, the search engine module 140 may continually improve the relevance of the provided results, and thereby further increase its utility to the users.

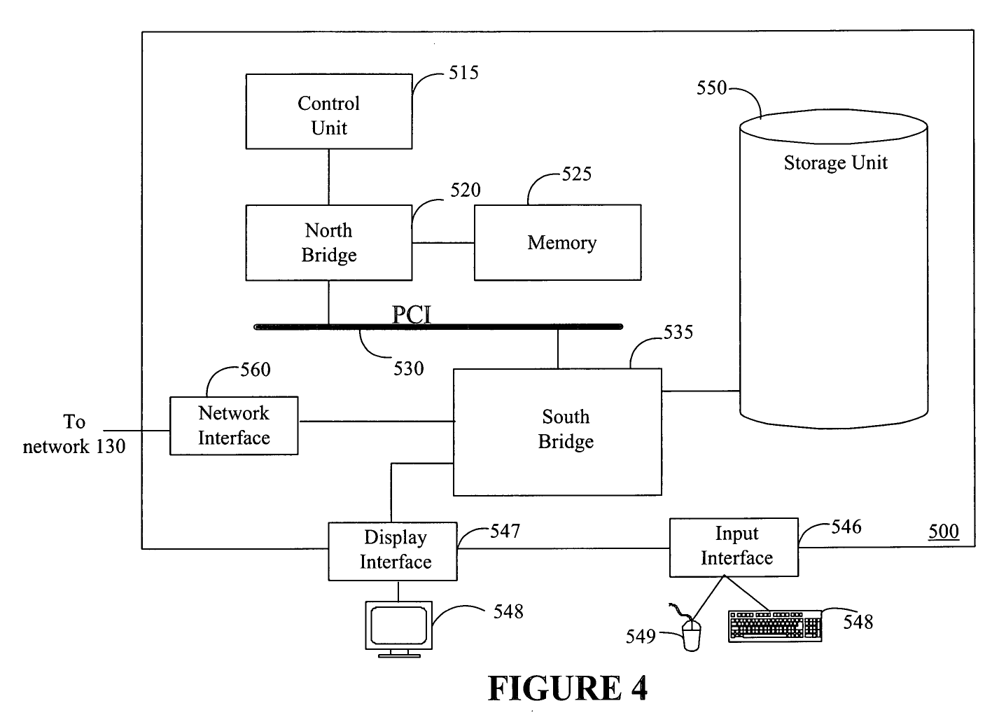

Referring now to FIG. 4, a stylized block diagram of a system 500 that may be implemented in the communications system of FIG. 1 is illustrated, in accordance with one embodiment of the present invention. That is, the system 500 may represent one embodiment of the device 105, device 110, and/or device 120, with each system being configured with the appropriate software configuration or configured with the appropriate modules 135, 140, 142, 150. The system 500 comprises a control unit 515, which in one embodiment may be a processor that is capable of interfacing with a north bridge 520. The north bridge 520 provides memory management functions for a memory 525, as well as serves as a bridge to a peripheral component interconnect (PCI) bus 530. In the illustrated embodiment, the system 500 includes a south bridge 535 coupled to the PCI bus 530.

A storage unit 550 is coupled to the south bridge 535. The software installed in the storage unit 550 may depend on the features to be performed by the system 500. For example, if the system 500 is implemented as the device 105 of FIG. 1, then the storage unit 550 may include the search module 135. If the system 500 is implemented as the device 105 of the FIG. 1, then the storage unit 550 may include at least the search engine module 140. If the system 500 is implemented as the device 120, then the storage unit 550 may include the web server module 150. The modules 135, 140, 142, 150 may be executable by the control unit 515. Although not shown, it should be appreciated that in one embodiment an operating system, such as Windows®, Disk Operating System®, Unix®, OS/2®, Linux®, MAC OS®, or the like, may be stored on the storage unit 550 and executable by the control unit 515. The storage unit 550 may also include device drivers for the various hardware components of the system 500.

In the illustrated embodiment, the system 500 includes a display interface 547 that is coupled to the south bridge 535. The system 500 may display information on a display device 548 via the display interface 547. The south bridge 535 of the system 500 may include a controller (not shown) to allow a user to input information using an input device, such as a keyboard 548 and/or a mouse 549, through an input interface 546.

The south bridge 535 of the system 500, in the illustrated embodiment, is coupled to a network interface 560, which may be adapted to receive, for example, a local area network card. In an alternative embodiment, the network interface 560 may be a Universal Serial Bus interface or an interface for wireless communications. The system 500 communicates with other devices coupled to the network 130 through the network interface 560. Although not shown, associated with the network interface 560 may be a network protocol stack, with one example being a UDP/IP (User Datagram Protocol/Internet Protocol) stack. UDP is described in RFC 768, entitled “User Datagram Protocol,” dated August 1980. In one embodiment, both inbound and outbound packets may be passed through the network interface 560 and the network protocol stack.

It should be appreciated that the configuration of the system 500 of FIG. 4 is exemplary in nature and that, in other embodiments the system 500 may include fewer, additional, or different components without deviating from the spirit and scope of the present invention. For example, in an alternative embodiment, the system 500 may not include a north bridge 520 or a south bridge 535, or may include only one of the two bridges 520, 535, or may combine the functionality of the two bridges. As another example, in one embodiment, the system 500 may include more than one control unit 515. Similarly, other configurations may be employed consistent with the spirit and scope of the present invention.

The various system layers, routines, or modules may be executable control units (such as control unit 515 (see FIG. 4)). The control unit 515 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 515 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
receiving a search term from a user;
providing a search result to the user based on comparing at least a portion of the received search term with at least a portion of one or more entries stored in a database;
providing a feedback module to the user to monitor at least one online action of the user in response to providing the search result; and
receiving, from the feedback module, information associated with the at least one monitored user action to adjust at least one entry stored in the database.

2. The method of claim 1, wherein the act of receiving comprises receiving the information from a processor-based device associated with the user, and wherein the act of providing comprises providing a feedback module to the processor-based device of the user, collecting, using the feedback module, information associated with the at least one monitored user action, and providing, using the feedback module, the collected information over a network.

3. The method of claim 2, wherein providing the collected information comprises providing the collected information at least one of at selected time intervals and in selected data amounts.

4. The method of claim 2, wherein providing the feedback module comprises providing a copy of the feedback module in response to determining that the processor-based device does not have a copy of the feedback module.

5. The method of claim 1, wherein providing the result comprises providing a plurality of results, and wherein the act of providing the feedback module comprises providing the feedback module to monitor at least one of how quickly the user selects a selected result from the plurality of results, a position of a result selected by the user relative to the plurality of results provided, how long the user stays on a webpage associated with a result selected by the user, which webpages associated with the one or more of the plurality of results a user visits in response to being provided the results, and if the user resubmits the search term.

6. The method of claim 1, further comprising at least one of adjusting a meta tag associated with the at least one entry stored in the database, removing the at least one entry stored in the database, and adjusting data associated with the at least one entry stored in the database.

7. The method of claim 1, further comprising adjusting the at least one entry stored in the database to improve the relevancy of that entry.

8. An article comprising one or more machine-readable storage media containing instructions that when executed enable a processor to:
receive a search term from a user;
provide a search result to the user based on comparing at least a portion of the received search term with at least a portion of one or more entries stored in a database;
provide a feedback module to the user to monitor at least one online action of the user in response to providing the search result; and
receive, from the feedback module, information associated with the at least one monitored user action to adjust at least one entry stored in the database.

9. The article of claim 8, wherein the instructions when executed enable the processor to receive the information from a processor-based device associated with the user and to provide a feedback module to the processor-based device of the user, collect, using the feedback module, information associated with the at least one monitored user action, and provide, using the feedback module, the collected information over a network.

10. The article of claim 9, wherein the instructions when executed enable the processor to provide the collected information at least one of at selected time intervals and in selected data amounts.

11. The article of claim 9, wherein the instructions when executed enable the processor to provide a copy of the feedback module in response to determining that the processor-based device does not have a copy of the feedback module.

12. The article of claim 8, wherein the instructions when executed enable the processor to provide a plurality of results and to provide the feedback module to monitor at least one of how quickly the user selects a selected result from the plurality of results, a position of a result selected by the user relative to the plurality of results provided, how long the user stays on a webpage associated with a result selected by the user, which webpages associated with the one or more of the plurality of results a user visits in response to being provided the results, and if the user resubmits the search term.

13. The article of claim 8, wherein the instructions when executed enable the processor to adjust a meta tag associated with the at least one entry stored in the database, remove the at least one entry stored in the database, and adjust data associated with the at least one entry stored in the database.

14. An apparatus, comprising:
a storage unit having stored therein a database; and
a control unit communicatively coupled to the storage unit, the control unit adapted to:
receive a search term from a user;
provide a search result to the user based on comparing at least a portion of the received search term with at least a portion of one or more entries stored in the database;
provide a feedback module to the user to monitor at least one online action of the user in response to providing the search result; and
receive, from the feedback module, information associated with the at least one monitored user action to adjust at least one entry stored in the database.

15. The apparatus of claim 14, wherein the control unit is adapted to receive the information from a processor-based device associated with the user and to provide a feedback module to the processor-based device of the user, collect, using the feedback module, information associated with the at least one monitored user action, and provide, using the feedback module, the collected information over a network.

16. The apparatus of claim 15, wherein the control unit is adapted to provide the collected information at least one of at selected time intervals and in selected data amounts.

17. The apparatus of claim 15, wherein the control unit is adapted to provide a copy of the feedback module in response to determining that the processor-based device does not have a copy of the feedback module.

18. The apparatus of claim 14, wherein the control unit is adapted to provide a plurality of results and to provide the feedback module to monitor at least one of how quickly the user selects a selected result from the plurality of results, a position of a result selected by the user relative to the plurality of results provided, how long the user stays on a webpage associated with a result selected by the user, which webpages associated with the one or more of the plurality of results a user visits in response to being provided the results, and if the user resubmits the search term.

19. The apparatus of claim 14, wherein the control unit is adapted to adjust a meta tag associated with the at least one entry stored in the database, remove the at least one entry stored in the database, and adjust data associated with the at least one entry stored in the database.

20. The apparatus of claim 14, wherein the control unit is further adapted to adjust the at least one entry stored in the database to improve the relevancy of that entry.
